(19) United States
(12) Patent Application Publication
(10) Pub. No.: US 2022/0020249 A1
(43) Pub. Date: Jan. 20, 2022

(54) OCCUPANCY INDICATOR DEVICE

(71) Applicant: Luys Systems Inc., San Jose, CA (US)

(72) Inventor: Daniel Castellano, Cupertino, CA (US)

(21) Appl. No.: 17/374,209

(22) Filed: Jul. 13, 2021

Related U.S. Application Data
(60) Provisional application No. 63/053,054, filed on Jul. 17, 2020.

(51) Int. Cl. G08B 5/38; H05B 47/115; H05B 47/11; G06N 20/00

(52) U.S. Cl. CPC G08B 5/38; G06N 20/00; H05B 47/11; H05B 47/115

(57) ABSTRACT

An occupancy indicator device to indicate occupancy of a stall includes a control unit having a motion sensor to detect motion of a door of the stall, an inertial measurement unit (IMU) to monitor a position of the door, an occupancy sensor to detect movement of an object in the stall, and an ambient light sensor to determine a status of a light of the stall. The control unit also includes a processor that executes a Machine Learning (ML) algorithm using data captured by the sensors to determine an occupancy status of the stall and generate data pertaining to stall occupancy, duration of each usage, and when corresponding stall was serviced. A light indicator system is disposed outside of the door and in communication with the control unit. A color of the light indicator system is responsive to a combination of sensor inputs feeding the ML algorithm.

### CROSS-REFERENCE TO RELATED APPLICATION(S)

This application claims priority to and the benefit of U.S. Provisional Patent Application No. 63/053,054, filed Jul. 17, 2020, the entire disclosure of which is hereby incorporated by reference.

### TECHNICAL FIELD

The present disclosure relates to occupancy sensing and indication within a specific area such as a changing room, a single user washroom (or bathroom) stall. More specifically, the present disclosure pertains to occupancy sensing and indication within the specific area.

### BACKGROUND

Gyms, stadiums, airports, convention centers, shopping malls, and other small and large venues may have one or more stalls, for example, one or more changing room(s), single user washroom(s) or bathroom(s), family changing rooms, or even a reticulated restroom containing several washroom or bathroom stalls physically separated from one another. For using a stall, patrons may first need to attempt an opening of a door of the stall, for example, the changing room, washroom stall or bathroom stall to discern if the corresponding stall is available. For restrooms with multiple stalls, the arrangement of stalls in an elongated corridor in the restroom may make it difficult for users, who usually wait near an entrance of the restroom, to determine which stalls are vacant. In such configurations of restrooms, the occupancy status of the stall becomes even more difficult to determine as the distance from the stall increases. An empty stall may remain unoccupied, and unused, and may increase wait times for users who desire to use the stalls present in the restroom. Also, corresponding landlord and building manager is not able to remotely assess current occupancy status or capture, store and analyze historical usage and service data. Data pertaining to usage patterns of stalls may need to be analyzed to enable more efficient servicing of changing rooms, bathrooms, or washrooms as such data can help optimize, or reduce, for example, maintenance routines, for instance, janitor effort in the case of bathroom stalls or washroom stalls.

Presently, known configurations of changing rooms, bathrooms or washrooms are unable to display locally, that is to patrons, or users, of the bathroom, the washroom, or the changing room if the corresponding stall, or type of stall, is currently occupied or not i.e., vacant, and therefore, available for use. In some configurations of such stalls, signs denoting the occupancy status of the stalls are fixed orthogonal to corresponding door faces, so there is limited visibility to users wishing to view from a skewed, or a side, viewing angle. In other configurations of such stalls, a light indicator may be suspended from the ceiling entailing, or requiring, improved dexterity on the part of the user, or patron, i.e., of the neck muscles to look up and thus makes it difficult for the user, or patron, to readily know the occupancy status of such stall. In some cases, an incorrect sign, or display, of the occupancy status may be rendered if the door is ajar and someone is still inside the stall. Also, existing configuration of stalls may not be connected via the Internet, and hence, may not capture any historical status of usage or service data.

### SUMMARY

According to an aspect of the present disclosure, an occupancy indicator device to indicate occupancy of a stall is provided. The occupancy indicator device includes a control unit having a motion sensor configured to detect motion of a door of the stall, an inertial measurement unit (IMU) configured to monitor a position of the door, an occupancy sensor configured to detect movement of an object in the stall, and an ambient light sensor configured to determine a status of an ambient light in the stall. The motion sensor, the IMU, the oocupancy sensor and the ambient light sensor may be enclosed in a housing having a U-shaped bracket. The control unit also includes a processor that is configured to execute a Machine Learning (ML) algorithm using data captured by the motion sensor, the IMU and the ambient light sensor to determine an occupancy status of the stall and generate data pertaining to stall occupancy, duration of each usage, and when corresponding stall was serviced. The occupancy indicator device also includes a light indicator system that is disposed outside of the door and communicatively coupled to the control unit through power and control wires. A color of the light indicator system is responsive to a combination of sensor inputs feeding the ML algorithm.

In another aspect of the present disclosure, an occupancy indicator device to indicate occupancy of a stall is provided. The occupancy indicator device includes a control unit having a motion sensor configured to detect motion of a door of the stall, an inertial measurement unit (IMU) configured to monitor a position of the door, an occupancy sensor configured to detect movement of an object in the stall, and an ambient light sensor configured to determine a status of a light in the stall. The control unit also includes a processor that is configured to execute a ML algorithm using data captured by the motion sensor, the IMU and the ambient light sensor to determine an occupancy status of the stall and generate data pertaining to stall occupancy, duration of each usage, and when corresponding stall was serviced. The occupancy indicator device also includes a light indicator system that is positioned outside of the door and in wireless communication with the control unit. A color of the light indicator system is responsive to a combination of sensor inputs feeding the ML algorithm.

In yet another aspect of the present disclosure, a computer implemented method to indicate occupancy of a stall includes detecting an occupancy status of the stall using a motion sensor, monitoring a position of a door of the stall using an inertial measurement unit, determining a status of a light of the stall using an ambient light sensor. The method further includes executing, by a processor, a ML algorithm using data captured by the motion sensor, the IMU and the ambient light sensor. The method further includes determining, by the processor, an occupancy status of the stall, and generating, by the processor, data pertaining to stall occupancy, duration of each usage, and when corresponding stall was serviced. The method further includes indicating occupancy of the stall, via a light indicator system disposed outside of the door, wherein a color of the light indicator system is responsive to a combination of sensor inputs feeding the ML algorithm.

### BRIEF DESCRIPTION OF DRAWINGS

The following detailed description of the preferred embodiments of the present disclosure will be better understood when read in conjunction with the appended drawings. The present disclosure is illustrated by way of example, and not limited by the accompanying figures, in which like references indicate similar elements.

FIG. 1A is a diagram showing a front view of a stall and an occupancy indicator device, according to an exemplary embodiment.

FIG. 1B is a diagram showing a top view of the stall, according to an exemplary embodiment.

FIG. 1C is a diagram showing a side view of the stall, according to an exemplary embodiment.

FIG. 2A is a diagram showing a perspective view of the occupancy indicator device showing a control unit and a light indicator system enclosed within a housing, according to an exemplary embodiment.

FIG. 2B is a diagram showing a side view of the occupancy indicator device including the control unit and the light indicator system communicatively coupled using power and control wires, according to an exemplary embodiment.

FIG. 3 is a block diagram showing the control unit of the occupancy indicator device, according to an exemplary embodiment.

FIG. 4 is a block diagram showing the light indicator system of the occupancy indicator device, according to an exemplary embodiment.

FIG. 5 is a block diagram showing an occupancy indicator device in which the control unit and the light indicator system are physically separated, according to an exemplary embodiment.

FIG. 6 is a block diagram showing a perspective view of the occupancy indicator device and the control unit, according to an exemplary embodiment.

FIG. 7A is a diagram showing a side view of a bathroom with the occupancy indicator device mounted in a first configuration in which the light indicator system is positioned on the wall outside of the bathroom and the control unit is positioned on a side of a bathroom door that faces an inside of the bathroom, according to an exemplary embodiment.

FIG. 7B is a diagram showing a side view of the bathroom with the occupancy indicator device mounted in a second configuration in which the light indicator system is positioned on a front face of the bathroom door and the control unit is positioned on an opposite side wall of the bathroom door, according to an exemplary embodiment.

FIG. 8 is a block diagram showing the occupancy indicator device, according to an exemplary embodiment.

FIG. 9 is a block diagram showing the control unit of the occupancy indicator device, according to an exemplary embodiment.

FIG. 10 shows a flow diagram to indicate occupancy of the stall, in accordance with an exemplary embodiment.

### DETAILED DESCRIPTION

The detailed description of the appended drawings is intended as a description of preferred embodiments of the present disclosure and is not intended to represent the only form in which the present disclosure may be implemented or practiced. It is to be understood that the same or equivalent functions may be accomplished by different embodiments that are intended to be encompassed within the spirit and scope of the present disclosure.

As used in the specification and claims, the singular forms “a”, “an” and “the” include plural references unless the context clearly dictates otherwise. For example, the term “an article” may include a plurality of articles unless the context clearly dictates otherwise.

Those with ordinary skill in the art will appreciate that elements in the figures are diagrammatically illustrated for simplicity and clarity and hence, may not be necessarily drawn to scale. For example, dimensions of some elements in the figures may be exaggerated, relative to other elements, in order to improve the understanding of the present disclosure.

There may be additional components described in the present disclosure that are not depicted on the appended drawings. In the event, such a component is described, but not depicted in a drawing, the absence of such a component from the drawing should not be considered as an omission of such design from the specification. In fact, such omission may have been willful and deliberately carried out to prevent obscuring more pertinent details of the present disclosure whilst further simplifying and clarifying the present disclosure.

As required, detailed embodiments of the present disclosure are disclosed herein; however, it is to be understood that the disclosed embodiments are merely exemplary of the present disclosure, which can be embodied in various forms. Therefore, specific structural and functional details disclosed herein are not to be interpreted as limiting, but merely as a basis of support for the claims and as a representative basis for teaching one skilled in the art to employ the present disclosure on virtually any appropriately designed structure, for example, on chairs in a theatre or a stadium to know occupancy status thereof. Further, the terms and phrases used herein are not intended to be limiting but rather to provide an understandable description of the present disclosure.

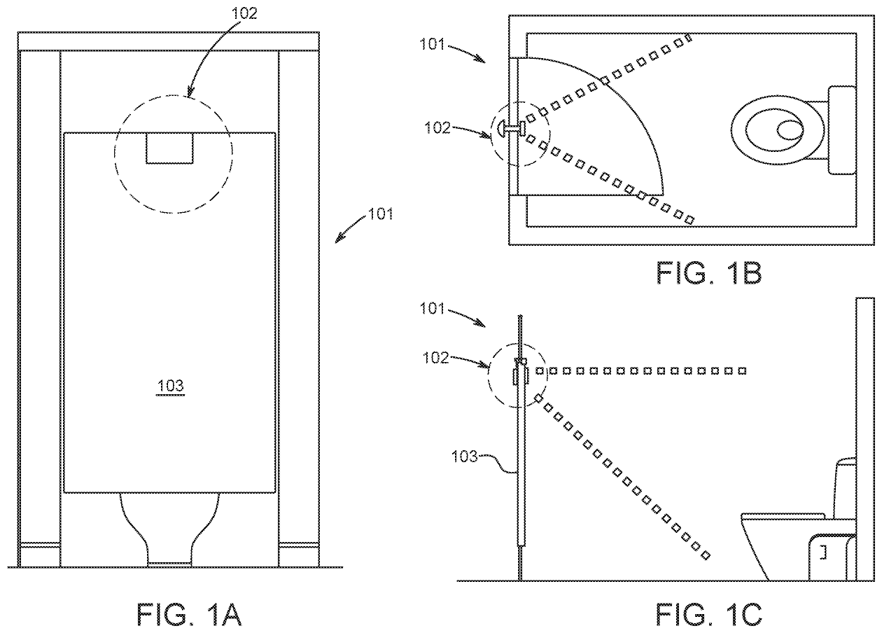

FIG. 1A is a diagram showing a front view of a stall 101 and an occupancy indicator device 102 mounted on a door 103 of the stall 101, according to an exemplary embodiment. With reference to FIG. 1A, there is shown a front view of a stall 101 and an occupancy indicator device 102. For example, the stall 101 may be a bathroom stall or a washroom stall. In yet another example, the stall 101 may embody a changing room, for instance, a single user changing room or a multi-user changing room such as a family changing room. In the present disclosure, the term stall 101 may be construed as including changing rooms, washrooms, or bathrooms where more than one person can be accommodated at a given point in time or a changing room, a washroom, or a bathroom where only a single user may be accommodated at a given point in time.

In an embodiment, the stall 101 and a corresponding door 103 of the stall 101 in the present disclosure may hereinafter be explained in conjunction with, or in reference to, the bathroom, for example, as ‘the stall’ and as ‘the door’ respectively. However, such designated, or specific type of, use of the stall 101 disclosed herein is merely for illustrative purpose and explanatory in nature, and therefore, non-limiting of this disclosure. Persons skilled in the art will acknowledge that the present disclosure can be similarly applied to other types of stalls, including but not limited to, changing room(s), washrooms, or other reticulated enclosures such as restrooms containing several changing rooms, washrooms, or bathrooms, in the form of stalls that are physically separated from one another wherein each of the stalls in the reticulated enclosure may be provided with an occupancy indicator device 102.

In an embodiment, the occupancy indicator device 102 is configured to be installed on top of a door 103 using a tamper proof mounting technique. For example, using rivets or nuts, bolts, and screws, such that installation and removal of the occupancy indicator device 102 does not damage the door 103 yet prevents miscreants from stealing, or tampering, the occupancy indicator device 102. During installation, if any damage occurs to the door 103, for example, due to a screw hole, such damage may be minimal, invisible, and easily repaired so that a new door does not have to be procured for subsequent use of the stall 101 as a whole or the door 103 alone. The occupancy indicator device 102 merely requires commonly known hand tools such as a screwdriver for installation, where installation would take no more than a few minutes, for example, 10 to 15 minutes, and could be accomplished by a person skilled in the art. Any air gap between the occupancy indicator device 102 and the door 103 may be reduced to a minimum to prevent, or at least minimize, a possibility of theft or vandalism. In production, the occupancy indicator device 102 may be resistant to mold and rust, is easy to install, theft proof, aesthetically pleasing, and of rugged design in addition to being waterproof, or at least, water resistant, for example, the occupancy indicator device 102 may be built in compliance with resistance to water splashes, for example, IP54 to IP67.

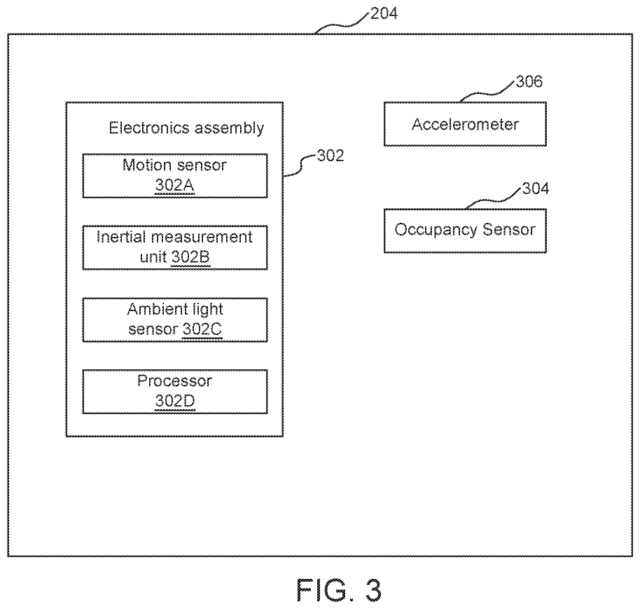

FIG. 1B is a diagram showing a top view of the stall 101, according to an exemplary embodiment. With reference to FIG. 1B, there is shown the occupancy indicator device 102 that may be disposed at a top middle portion of the door 103, and includes, amongst other things, a motion sensor 302A (shown in FIG. 3) to detect occupancy status of the stall 101 by detecting motion therein. While the device occupancy indicator 102 is shown to be located on the middle portion of the door 103, it would be apparent to a person of ordinary skill in the art, that the occupancy indicator device 102 may be located anywhere on the door 103, for example, mounted at any position along a width of the top portion of the door 103.

FIG. 1C is a diagram showing a side view of the stall 101, according to an exemplary embodiment. With reference to FIG. 1C, there is shown the occupancy indicator device 102 that may be disposed at the top portion of the door 103 so that the motion sensor 302A is configured to detect occupancy status of the stall 101 by detecting motion of objects, for example, users of the stall 101.

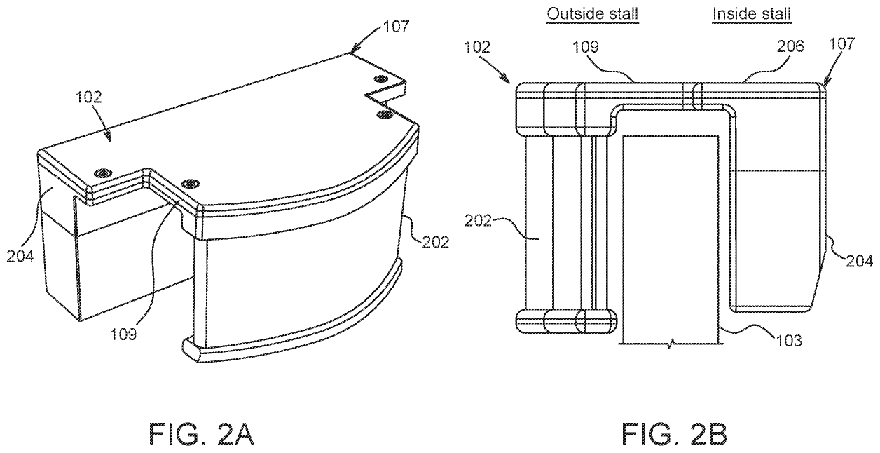

FIG. 2A is a diagram showing a perspective view of the occupancy indicator device 102 showing a control unit 204 and a light indicator system 202 enclosed within a housing 107, according to an exemplary embodiment. FIG. 2A is described in conjunction with FIGS. 1A-1C. With reference to FIG. 2A, there is shown the device occupancy indicator 102 that is enclosed within a housing 107 having a U-shaped bracket 109 running over the top portion of the door 103 (see FIG. 2B). For example, a width of the U-shaped bracket 109 may be approximately 1″ long and 3/8″ thick. In an embodiment, the occupancy indicator device 102 includes a light indicator system 202 and a control unit 204 enclosed within the housing 107. Further, the light indicator system 202 is communicatively coupled to the control unit 204 using power and control wires that are also enclosed within the housing 107 and run internal to the U-shaped bracket 109 of the housing 107.

FIG. 2B is a diagram showing a side view of the occupancy indicator device 102 including the control unit 204 and the light indicator system 202 communicatively coupled using power and control wires, according to an exemplary embodiment. FIG. 2B is described in conjunction with FIGS. 1-2A. With reference to FIG. 2B, the control unit 204 is positioned on a side of the door 103 facing the inside of the stall 101 while the light indicator system 202 is positioned on the door 103 outside of the stall 101 so that a user can easily view the light indicator system 202. The control unit 204 controls an operation of the light indicator system 202.

In an embodiment, a profile of the light indicator system 202 may be polygonal, for example, having a quadrangular cross-section, or at least partially rounded, for example, in a substantially cylindrical, or elliptical manner so as to protrude away from the door 103 with at least a 180-degree field of view that provides ease of viewing to the user, especially, when the user is at a skewed, or side, viewing angle to a front face of the door 103 on which the light indicator system 202 is positioned. Moreover, a color of the light indicator system 202 is responsive to a combination of sensor inputs feeding a processor 302D (shown in FIG. 3) of the control unit 204. The processor 302D is configured to execute a machine learning (ML) algorithm to determine if the stall 101 is empty or occupied.

In an embodiment, the light indicator system 202 may operatively support a display of at least the colors red, blue, and green. In an example, the color green may be lit when the stall 101 is vacant and the color red may be lit when the stall 101 is occupied. The light indicator system 202 may also be configured to display another color or flash a pre-determined color, for example, the red color itself at a pre-determined frequency for indicating other operational conditions such as a low-battery status, a diagnosed fault condition besides other types of operational conditions commonly known in the art. Moreover, a number of colors and a state of the colors displayed by the light indicator system 202 may also be configured prior to installation and use depending on specific requirements of an application. For example, the light indicator system 202 may be configured to display the colors red and green for standard stalls. In another instance, the light indicator system 202 may be configured to display red and blue colors for stalls that are designated for use by differently abled persons. Moreover, varying states (e.g., solid, or intermittent, for example, flashing fast, flashing slow, or switching between colors) may also be implemented for use by the light indicator system 202 for indicating different conditions of use based on sensor data while suiting one or more specific requirements of an application.

FIG. 3 is a block diagram showing the control unit 204 of the occupancy indicator device 102, according to an exemplary embodiment. FIG. 3 is described in conjunction with FIGS. 1-2B. With reference to FIG. 3, there is shown an electronics assembly 302 that is enclosed within a portion of the housing that is positioned on the side of the door 103 facing the inside of the stall 101. The electronics assembly 302 includes a motion sensor 302A, an inertial measurement unit 302B, an ambient light sensor 302C and the processor 302D. An occupancy sensor 304 (similar to the motion sensor 302A) is configured to detect if the stall 101 is occupied or not. In an embodiment, the electronics assembly 302 further includes a set of electronic devices (not shown) mounted onto a single printed circuit card. For example, the electronic devices may include, a microcontroller, a Bluetooth radio, a real time clock (RTC), and multiple sensors coupled to the door 103. Examples of the multiple sensors may also include a light intensity sensor, a motion sensor, a battery life sensor, and an inertial measurement unit (IMU) sensor 302B. The IMU sensor 302B may be used to monitor the position of the door 103. The electronic assembly 302 further includes an internal clock and a memory to record historical, time-stamped activity for each sensor data. The light intensity sensor is configured to put the system in sleep mode to extend battery life when lights of the stall 101 are off. In an embodiment, the housing of the electronics assembly 302 may include arrangements or provisions for installing ambient light and motion sensors. For example, such provisions may include physical openings, or openings to incorporate transparent radio frequency (RF) light sensitive materials.

In an embodiment, the electronic assembly 302 may include the processor 302D that implements a supervised ML based algorithm to make use of data captured by the sensors such as motion sensor 302A, ambient light sensor 302C, IMU 302B, Passive Infrared Sensor (PIR), etc., to classify the current stall condition as “occupied” or “not occupied”. Examples of ML algorithms may include Support Vector Machine (SVM), Decision Trees, k-nearest neighbor, Naive Bayes, and Logistic Regression. In an embodiment, an accelerometer 306, for example, an ultra-low-power 3-axis accelerometer may be used to detect the door motion and the door open/close event.

In an embodiment, the electronics assembly 302 may include a wireless device or a radio transceiver, also referred to as a radio module for transmitting time-stamped sensor data to other devices such as a wireless hub/mobile device/personal computer. The data may be sent via a wireless gateway to a cloud platform. The data may include information regarding when corresponding stall 101 was occupied, duration of each usage of the stall 101, and when the corresponding stall 101 was serviced. The cloud platform may provide an application to be executed on the mobile device/personal computer to display current and historical data of each stall 101. The cloud platform may also process time-stamped sensor data to predict and pre-alert service personnel when the stall 101 needs servicing and pass the data for integration to other cloud services. The user, for example, control personnel, or service crew, may label the control unit 204 associated with the occupancy indicator device 102 so that it may be uniquely identified. When within range of the control unit 204, the application may be able to upload the control data, and display time series data showing when the stall 101 was empty and occupied. The application may enable the user to set the time/date window (start and stop time/date). The application may display the number of times the stall 101 was used in a given period (e.g., day/week/month). The application may also report a percentage of battery life remaining of corresponding occupancy indicator device 102.

In an embodiment, the mobile application may push the data to the cloud platform for storage and remote access by corresponding building owner/landlord for further analysis and display. In another embodiment, there may be provided a dedicated access point that monitors all the control units (e.g., 204) and sends data to the cloud platform. The cloud platform may send a notification to a service crew when stall 101 has been used a threshold number of times and needs servicing, so that the service crew may record each time the stall 101 is serviced. The control unit may further be integrated to a smart building management system. Also, a wireless hub portable service notifier may be provided therein to record when a service unit is in close proximity to capture when stall 101 is serviced.

In an embodiment, the light indicator system 202 may be configured to work in cooperation with the control unit 204. The light indicator system 202 may be configured to be communicatively coupled with the control unit 204. The light indicator system 202 may be communicatively coupled with the cloud platform via the wireless gateway in the electronics assembly 302. The light indicator system 202 may be configured to detect change state, indicate it and send alerts/notifications to the cloud platform or a building management system or a communication device of a supervisor. In an embodiment, the light indicator system 202 may transmit or send information related to the color and the state of the color indicating operational conditions. For instance, the light indicator system 202 may work in cooperation the electronics assembly 302 of the control unit 204 to determine operational conditions. For example, such operating conditions may correspond to a duration of the occupancy of the stall 101. When the stall 101 is occupied for a longer duration than that of a predetermined threshold value, the light indicator system 202 may be configured to work in cooperation with the control unit 204 to send notifications to the cloud platform or the supervisor indicating the operating condition or a change in the operating condition. The change in operating conditions may include a change in temperature around the stall 101. For instance, when the electronics assembly 302 in the control unit 204 sense that the temperature around the stall 101 is unusual and outside a specific range, the light indicator system 202 may indicate it by changing the color. Further change in operating conditions may include a status of low battery of the light indicator system 202 or a sudden change in the ambient light. In an embodiment, the light indicator system 202 may indicate such changes and cooperatively work with the control unit 204 to send notifications to the cloud platform or the building management system or the supervisor.

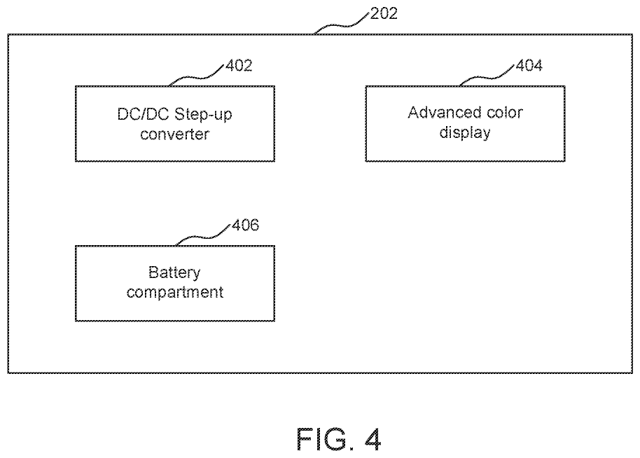

FIG. 4 is a block diagram showing the light indicator system 202 of the occupancy indicator device 102, according to an exemplary embodiment. FIG. 4 is described in conjunction with FIGS. 1-3. With reference to FIG. 4, there is shown the light indicator system 202 that includes a DC/DC step-up converter 402, an advanced color display 404, and a battery compartment 406 containing replaceable batteries. The advanced color display 404 is configured to support, at a minimum, the colors green, and red. The color green is lit when the stall 101 is vacant and color red is lit when the stall 101 is occupied. The lights can be configured to flash at different rates indicating different conditions. The light indicator system 202 may include a speaker for an audible alarm that indicates a low-battery status or that service is required. In an example, the battery compartment 406 may output a voltage of 3.7V, and the DC/DC step-up converter 402 may convert the battery output to voltage levels of +5V, −5V, +15V and −15V.

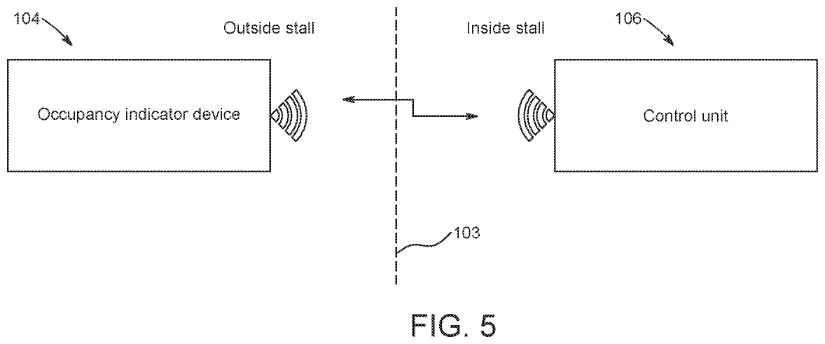

FIG. 5 is a block diagram showing an occupancy indicator device 104 in which the control unit 106 and the light indicator system 202 are physically separated, according to an exemplary embodiment. FIG. 5 is described in conjunction with FIGS. 1-4. With reference to FIG. 5, there is shown a second embodiment of the occupancy indicator device 104. The occupancy indicator device 104 may be powered by a basic battery unit that may be mounted on the bath stall door 103, such that the occupancy indicator device 104 is outside the stall 101. The control unit 106 may be mounted on a corresponding wall, such that the control unit 106 is inside the stall 101. In the second embodiment, the control unit 106 and the occupancy indicator device 104 are physically separated but a communicatively coupled via point to point or wireless mesh communication technology.

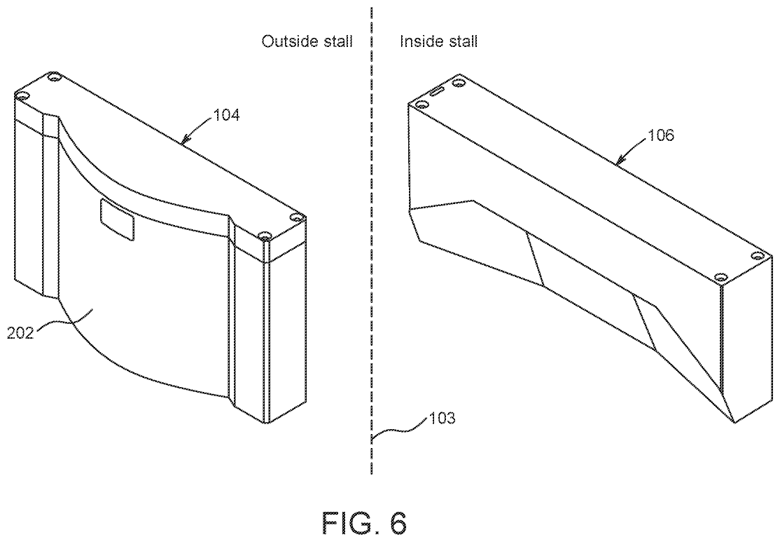

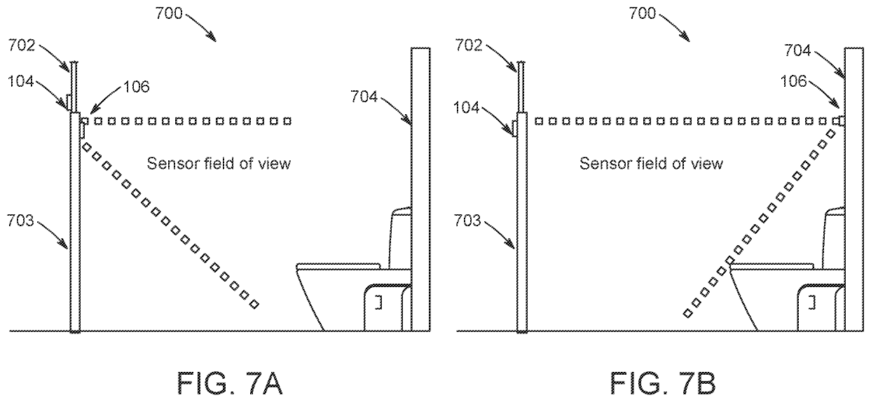

FIG. 6 is a diagram showing a perspective view of the control unit 106 and the light indicator system 202, according to a second embodiment of the occupancy indicator device 102. FIG. 6 is described in conjunction with FIG. 5. With reference to FIG. 6, there is shown the occupancy indicator device 104 and the control unit 106. In this embodiment of the occupancy indicator device 104, the light indicator system 202 and the control unit 106 are physically separated but communicatively coupled via a wireless communication link, for example, Bluetooth, or other Internet protocols such as Local Area network (LAN), or Wi-Fi, but not limited thereto. Further, the control unit 106 is positioned inside the stall 101, for example, on a back wall of the stall (as exemplarily shown in the diagrammatic side view of FIG. 7B), a back side of the door 103 (as exemplarily shown in the diagrammatic side view of FIG. 7A), or a sidewall of the stall 101. Furthermore, the light indicator system 202 may be positioned on the door 103 outside of the stall 101 (as exemplarily shown in the diagrammatic side view of FIG. 7B), or on a wall 702 supporting the door 103 (as exemplarily shown in the diagrammatic side view of FIG. 7A) so that a user can easily view the light indicator system 202. As disclosed earlier herein, the control unit 106 controls the operation of the light indicator system 202.

In an embodiment, the light indicator system 202 may be polygonal, for example, having a quadrangular cross-section, or at least partially rounded, for example, in a substantially cylindrical, or elliptical manner so as to protrude away from the door 103 with at least a 180-degree field of view that provides ease of viewing to the user, especially, when the user is at a skewed, or side, viewing angle to a front face of the door 103 on which the light indicator system 202 is positioned. Moreover, a color of the light indicator system 202 is responsive to a combination of sensor inputs feeding the processor 302D (shown in FIG. 3) of the control unit 106. The processor 302D is configured to execute a ML algorithm to determine if the stall 101 is empty or occupied.

In an embodiment, the light indicator system 202 may operatively support a display of at least the colors red, blue, and green. In an example, the color green may be lit when the stall 101 is vacant and the color red may be lit when the stall 101 is occupied. The light indicator system 202 may also be configured to display another color or flash a pre-determined color, for example, the red color itself at a pre-determined frequency for indicating other operational conditions such as a low-battery status, a diagnosed fault condition besides other types of operational conditions commonly known in the art. Moreover, a number of colors and a state of the colors displayed by the light indicator system 202 may also be configured prior to installation and use depending on specific requirements of an application. For example, the light indicator system 202 may be configured to display the colors red and green for standard stalls. In another instance, the light indicator system 202 may be configured to display red and blue colors for stalls that are designated for use by differently abled persons. Moreover, varying states (e.g., solid, or intermittent i.e., flashing fast, flashing slow, or switching between colors) may also be implemented for use by the light indicator system 202 for indicating different conditions of use based on sensor data while suiting one or more specific requirements of an application.

FIG. 7A is a diagram showing a side view of a bathroom 700 with the occupancy indicator device 104 mounted in a first configuration in which the light indicator system 202 is positioned on the wall 702 outside of the bathroom 700 and the control unit 106 is positioned on a side of a bathroom door 703 that faces an inside of the bathroom 700, according to an exemplary embodiment. FIG. 7A is described in conjunction with FIGS. 5-6B. With reference to FIG. 7A, there is shown a side view of a bathroom 700 with the occupancy indicator device 104 mounted in a first configuration in which the light indicator system 202 is positioned on a wall 702 outside the bathroom 700 and the control unit 106 is positioned on a side of the bathroom door 703 facing an inside of the bathroom 700. In an embodiment, although the occupancy indicator device 104 is physically separated from the control unit 106, they communicate via point to point communication or via a wireless mesh technology. While the occupancy indicator device 104 is shown to be located on the wall 702, it would be apparent to a person of ordinary skill in the art, that the occupancy indicator device 104 may be located anywhere on the door 703, for example, mounted at any position along a width of the door 703.

FIG. 7B is a diagram showing a side view of the bathroom 700 with the occupancy indicator device 104 mounted in a second configuration in which the light indicator system 202 is positioned on a front face of the bathroom door 703 and the control unit 106 is positioned on an opposite side wall 704 of the bathroom 700, according to an exemplary embodiment. FIG. 7B is described in conjunction with FIGS. 3-4 and 5-7A. With reference to FIG. 7B, there is shown that the occupancy indicator device 104 that may be disposed in a second configuration in which the light indicator system 202 is positioned on a front face of the bathroom door 703 i.e., a face of the bathroom door 703 facing outside the bathroom 700 and the control unit 106 is positioned on another wall 704 of the bathroom 700 for example, the back wall 704 of the bathroom 700 that faces the inside of the bathroom 700. In an embodiment, the motion sensor 302A is configured to detect a motion of the bathroom door 703 easily and readily, while the occupancy sensor 304 is configured to detect movement of an object, for example, one or more persons in the bathroom 700. In an embodiment, the control unit 106 is positioned inside the bathroom 700 on the wall 704. As disclosed earlier herein and as shown in the views of 7A-7B, the light indicator system 202 and the control unit 106 are physically separated but they communicate via point to point communication or via a wireless mesh technology.

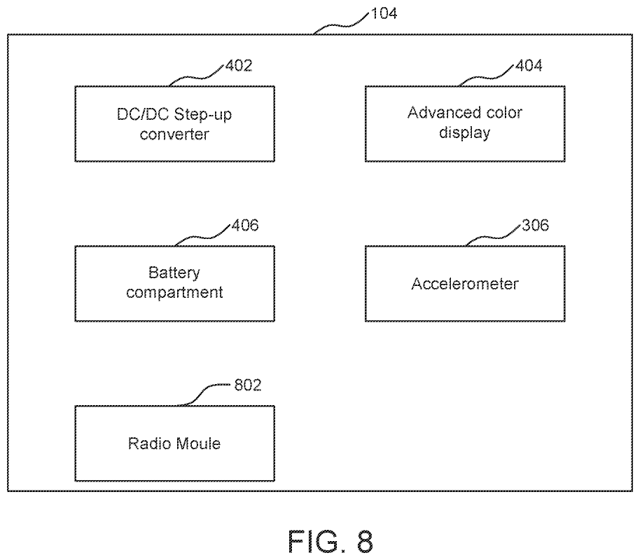

FIG. 8 is a block diagram showing the occupancy indicator device 104, according to an exemplary embodiment. FIG. 8 is described in conjunction with FIGS. 1-7B. With reference to FIG. 8, there is shown the occupancy indicator device 104 that includes the DC/DC step-up converter 402, the advanced color display 404, and the battery compartment 406 containing replaceable batteries. The advanced color display 404 is configured to support, at a minimum, the colors green, and red. The color green is lit when the stall 101 is vacant and color red is lit when the stall 101 is occupied. The lights can be made to flash at different rates indicating different conditions. The light indicator system 202 may include a speaker for an audible alarm that indicates a low-battery status or that service is required. In an embodiment, the battery compartment 406 may output a voltage of 3.7V, and the DC/DC step-up converter 402 may convert the battery output to voltage levels of +5V, −5V, +15V and −15V.

In an embodiment, the occupancy indicator device 104 may include a radio module 802, for example, the radio transceiver with antenna that provides proxy function to represent an edge network on a digital cloud that may be implemented with one or more data processing functions to realize various artificial intelligence (AI) inference tasks.

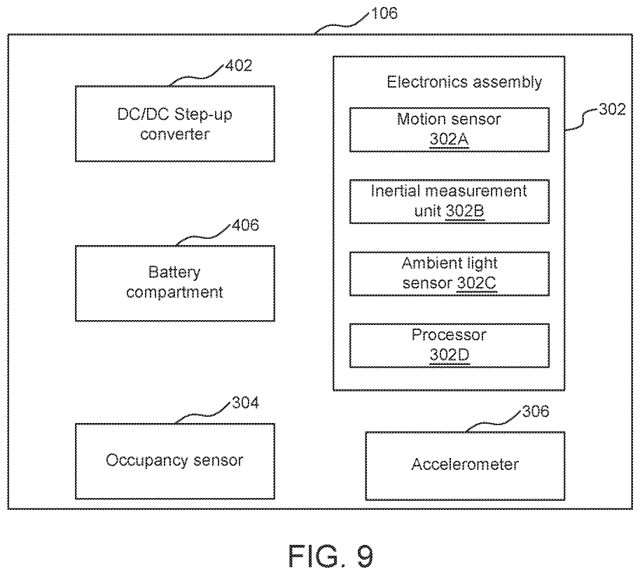

FIG. 9 is a block diagram showing the control unit 106, according to an exemplary embodiment. FIG. 9 is described in conjunction with FIGS. 1, 3, 4 and 8. The electronics assembly 302 may be enclosed within a portion of the housing 107 that houses the control unit 106 and is positioned facing the inside of the stall 101. The electronics assembly 302 includes the motion sensor 302A, the inertial measurement unit 302B, the ambient light sensor 302C and the processor 302D. The occupancy sensor 304 may include a 60 GHz Radar, or a passive Infrared (IR) sensor. In an embodiment, the electronics assembly 302 may include a set of electronic devices i.e., sensors 302A-302C, 304 and 306 that may be reside on a single, or multiple, printed circuit cards. the electronic devices may additionally include components such as, but not limited to, a microcontroller, a Bluetooth radio, a RTC, and the sensors 302A-302C, 304 and 306 disclosed earlier herein. Examples of other devices may include, but are not limited to, a battery life sensor that may indicate an amount of electric charge remnant in a battery of the occupancy indicator device 104 and an internal clock and memory that may facilitate recording of time-stamped activity for each data output by the sensor(s) to the processor 302D. Additionally, or optionally, the control unit 104 may also include a light intensity sensor that may be configured to put the system i.e., the occupancy indicator device 104 in sleep mode, for instance—to extend battery life, when one or more lights of the stall 101 are in an OFF state. In an embodiment of the present disclosure, the housing 109 may also define openings (not shown) for installing ambient light and motion sensors therein. These openings may be physical openings, or openings that incorporate transparent RF light sensitive materials.

In an embodiment, the processor 302D executes machine learning algorithms using the data that is captured by the sensors such as the motion sensor 302A, the IMU 302B, and the ambient light sensor 302C to classify the current stall condition as “occupied” or “not occupied”. Some examples of ML algorithms include, but are not limited to, SVM, Decision Trees, k-nearest neighbor, Naive Bayes, and Logistic Regression. In an embodiment, the accelerometer 306, for example, an ultra-low-power 3-axis accelerometer is used to detect the door 103 motion and the door open/close event.

In an embodiment, the radio module 802 of the electronics assembly 302 may include a wireless device or a wireless transceiver for transmitting time-stamped sensor data to other devices such as a mobile device or personal computer. The data may be sent via a wireless gateway to the digital cloud platform which in turn may transmit data to the mobile device or personal computer. The data may include information regarding when corresponding stall 101 was occupied, duration of each usage, and when corresponding stall 101 was serviced. The cloud platform may provide an application to be executed on the mobile device or personal computer to display current and historical usage and service related data of each stall 101. The cloud platform may process the time-stamped data to predict and alert service personnel when the stall 101 needs servicing and pass the data for integration to the mobile device or personal computer. Control personnel may initialize and designate each control unit 204 so that it may be uniquely identified with a specific stall 101, for instance, when multiple stalls are present. The control unit 106 and the application on the cloud platform may be able to upload the data, and display time series data showing when the stall 101 was empty and occupied. The application may enable the control personnel to set the time/date window (start and stop time/date). The application may display the number of times the stall 101 was used in a given period (e.g., day week/month). The application may also report a percentage of battery life remaining of corresponding occupancy indicator device 102.

In an embodiment of the present disclosure, the mobile application may push the data to the cloud platform for storage and remote access by corresponding building owner or landlord for further analysis. In another embodiment of the present disclosure, there may be provided a dedicated access point that monitors all control units and sends data to the cloud platform. The cloud platform may send a notification to service personnel, or crew, regarding when the stall 101 has been used a threshold number of times and needs servicing, so that the service crew may record each time the stall 101 is serviced. The control unit 106 may further be integrated with a smart building management system.

In an embodiment, the control unit 106 may include a DC/DC step-up converter 402, a color display 404, and a battery compartment 406 containing replaceable, or rechargeable, batteries. The color display 404 may be configured to support, at a minimum, the colors red, green, and blue. The color green may be lit when the stall 101 is vacant and color red may be lit when the stall 101 is occupied. The lights of the light indicator system 202 can be made to flash at different rates indicating different conditions. The light indicator system 202 may also include a speaker for providing an audible alarm that indicates a low-battery status or that service is required.

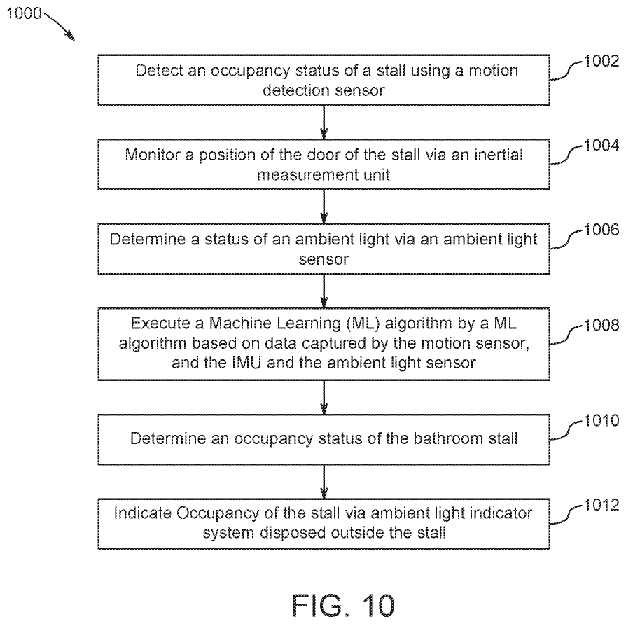

FIG. 10 shows a flow diagram 1000 to indicate occupancy of the stall 101, in accordance with an exemplary embodiment. The flow diagram 1000 is described in conjunction with FIGS. 1-9. As shown, at step 1002, the method 1000 includes detecting an occupancy status of the stall using the motion sensor 302A. At step 1004, the method 1000 includes monitoring a position of the door 103 of the stall 101 using the IMU 302B. At step 1006, the method 1000 includes determining a status of ambient light within the stall 101 using the ambient light sensor 302C. At step 1008, the method 1000 includes executing, by the processor 302D, the ML algorithm using data captured by the motion sensor 302A, the IMU 302B and the ambient light sensor 302C. At step 1010, the method 1000 includes determining an occupancy status of the stall 101, and generating data regarding stall occupancy, duration of each usage, and when corresponding stall was serviced. At step 1012, the method 1000 includes indicating the occupancy of the stall 101 using the light indicator system 106 disposed outside the stall 101.

In embodiments herein, the occupancy indicator device 102 may provide a solution for monitoring the occupancy in the stall. Deployment of the occupancy indicator device 102 does not require any major form of alterations to be carried out to existing buildings, stalls, or doors, thereby being easily retrofitted onto existing structures, and therefore, reducing costs associated with installation and subsequent maintenance of the occupancy indicator device 102. Moreover, the occupancy indicator device 102 may be implemented or deployed using low energy consumption components and technology, for example, an integrated Bluetooth Low Energy (BLE) client that may create access and communication with the cloud platform and other nearby devices.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor and a memory may be used to implement the above described embodiments. Further, the operations may be described as a sequential process; however, some of the operations may in fact be performed in parallel, concurrently, and/or in a distributed environment, and with program code stored locally or remotely for access by single or multiprocessor machines. In addition, in some embodiments the order of operations may be rearranged without deviating from the scope of present disclosure. While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

What is claimed is:

1. An occupancy indicator device to indicate occupancy of a stall, the occupancy indicator device comprising:
a control unit comprising:
a motion sensor configured to detect motion of a door of the stall;
an inertial measurement unit (IMU) configured to monitor a position of the door;
an occupancy sensor configured to detect movement of an object in the stall;
an ambient light sensor configured to determine a status of an ambient light in the stall; and
a processor configured to:
execute a machine learning algorithm using data captured by the motion sensor, the IMU and the ambient light sensor to determine an occupancy status of the stall, and
generate data pertaining to stall occupancy, duration of each usage, and when the stall was serviced; and
a light indicator system disposed outside of the door and communicatively coupled to the control unit through power and control wires, wherein a color of the light indicator system is responsive to a combination of sensor inputs feeding the machine learning algorithm.

2. The occupancy indicator device of claim 1, wherein the light indicator system supports colors including red, blue and green, and wherein the color green is continuously lit or flashing when the stall is vacant and the color red is continuously lit or flashing when the stall is occupied, and wherein the light indicator system is configured to flash lights at different rates indicating different conditions.

3. The occupancy indicator device of claim 1, wherein the control unit further comprises an internal clock and memory to record historical time-stamped activity for each sensor.

4. The occupancy indicator device of claim 1, wherein the control unit further comprises a light sensor that is used to initiate sleep mode to extend battery life when lights of the stall are turned off and to adjust an intensity of the light indicator system based on the ambient light.

5. The occupancy indicator device of claim 1, wherein the control unit further comprises a radio module for transmitting time-stamped sensor data to a wireless hub and a computing device.

6. The occupancy indicator device of claim 1, wherein the control unit is communicatively coupled to a smart building management system.

7. The occupancy indicator device of claim 1, wherein the motion sensor, the occupancy sensor and the ambient light sensor are enclosed in a housing having a U-shaped bracket.

8. An occupancy indicator device to indicate occupancy of a bathroom, the occupancy indicator device comprising:
a control unit disposed inside the bathroom, comprising:
a motion sensor configured to detect motion of a bathroom door;
an inertial measurement unit (IMU) configured to monitor a position of the bathroom door;
an occupancy sensor configured to detect movement of an object in the bathroom;
an ambient light sensor configured to determine a status of an ambient light of the bathroom; and
a processor configured to:
execute a machine learning algorithm using data captured by the motion sensor, the IMU and the ambient light sensor to determine an occupancy status of the bathroom, and
generate data pertaining to a bathroom occupancy, duration of each usage, and when the bathroom was serviced; and
a light indicator system disposed outside the bathroom door on a wall and disposed in wireless communication with the control unit, wherein a color of the light indicator system is responsive to a combination of sensor inputs feeding the machine learning algorithm.

9. The occupancy indicator device of claim 8, wherein the light indicator system supports colors including red, blue and green, and wherein the color green is continuously lit or flashing when the bathroom is vacant and the color red is continuously lit or flashing when the bathroom is occupied, and wherein the light indicator system is configured to flash lights at different rates indicating different conditions.

10. The occupancy indicator device of claim 8, wherein the control unit further comprises an internal clock and memory to record historical time-stamped activity for each sensor.

11. The occupancy indicator device of claim 8, wherein the control unit further comprises a light sensor that is used to initiate sleep mode to extend battery life when lights of the bathroom are turned off and to adjust an intensity of the light indicator system based on the ambient light.

12. The occupancy indicator device of claim 8, wherein the control unit further comprises a radio module for transmitting time-stamped sensor data to a wireless hub and a computing device.

13. The occupancy indicator device of claim 8, wherein the control unit is communicatively coupled to a smart building management system.

14. The occupancy indicator device of claim 8, wherein the light indicator system and the control unit are physically separate from each other.

15. A computer implemented method to indicate occupancy of a stall, comprising:
detecting an occupancy status of the stall using a motion sensor;
monitoring a position of a door of the stall using an inertial measurement unit (IMU);
determining a status of an ambient light of the stall using an ambient light sensor;
executing by a processor, a machine learning algorithm using data captured by the motion sensor, the inertial measurement unit and the ambient light sensor;
determining an occupancy status of the stall and generating data regarding a stall occupancy, duration of each usage and when the stall was serviced; and
indicating occupancy of the stall via a light indicator system disposed outside of the door, and communicatively coupled to a control unit, wherein a color of the light indicator system is responsive to a combination of one or more sensor inputs feeding the machine learning algorithm.

16. The computer implemented method of claim 15, wherein the light indicator system supports colors including green, and red, wherein the color green is continuously lit or flashing when the stall is vacant and the color red is continuously lit or flashing when the stall is occupied, and wherein the light indicator system is configured to flash lights at different rates indicating different conditions.

17. The computer implemented method of claim 15, further comprising: recording historical, time-stamped activity for each sensor data via the control unit.

18. The computer implemented method of claim 15, further comprising: initiating a sleep mode via the control unit when lights of the stall are turned off and to adjust an intensity of the light indicator system based on the ambient light.

19. The computer implemented method of claim 15, further comprising: transmitting time-stamped sensor data to a wireless hub and a computing device via a radio module in the control unit.

20. The computer implemented method of claim 15, wherein the control unit is communicatively coupled to a smart building management system.
